(19) United States
(12) Patent Application Publication
(10) Pub. No.: US 2026/0316491 A1
(43) Pub. Date: Oct. 15, 2026

(54) AXLE ASSEMBLY WITH A ROTARY FEED-THROUGH FOR A TIRE PRESSURE CONTROL SYSTEM

(71) Applicant: DEERE & COMPANY, MOLINE, IL (US)

(72) Inventors: TOBIAS STEINER, Hainfeld (DE); JONAS BUSE, Karlsruhe (DE); STEFAN HAUSER, Heidelberg (DE)

(21) Appl. No.: 19/449,655

(22) Filed: Jan. 15, 2026

(30) Foreign Application Priority Data
Apr. 10, 2025 (EP) 25169794.2

(51) Int. Cl. B60B 35/12; B60C 23/00; B60K 17/04; F16H 1/28; F16H 37/08; F16H 57/02; F16H 57/021; F16H 57/037

(52) U.S. Cl. CPC B60B 35/125; B60C 23/00345; B60K 17/046; F16H 1/28; F16H 37/082; F16H 57/021; F16H 57/037; B60C 2200/08; F16H 2057/02052

(57) ABSTRACT

An axle assembly having a rotary feed-through for a tire pressure control system of an agricultural tractor, includes a final drive housing including a planetary transmission having a final drive shaft including a sun gear, a ring gear fixed in relation to the final drive housing, a planet carrier including an axial flange, and a plurality of planet gears rotatably mounted on the planet carrier drivingly connected to an axle shaft rotatably mounted within the final drive housing and having an end portion rotationally fixed within an installation opening delimited by the axial flange, which includes a connecting channel for producing a compressed-air connection formed between a rotary feed-through extending on an outer circumference of the axial flange and an air inlet opening on the end portion of the axle shaft leading into a supply channel, which extends within the axle shaft.

### CROSS-REFERENCE TO RELATED APPLICATIONS

This application claims priority to European Patent Application No. 25169794.2, filed Apr. 10, 2025, which is hereby incorporated by reference.

### FIELD OF THE DISCLOSURE

The disclosure relates to an axle assembly having a rotary feed-through for a tire pressure control system, in particular for an agricultural tractor.

### BACKGROUND

The use of tire pressure control systems is widespread in particular in the sector of agricultural tractors. These make it possible, when driving over a field, to be able to adapt the tire contact surfaces in a manner that corresponds to the respective soil conditions. The tire contact surfaces are commonly adapted in such a way that excessive compression of the field surface is reduced by correspondingly reducing the tire inflation pressure and increasing the tire contact patch.

### SUMMARY

According to an aspect of the present disclosure, an axle assembly having a rotary feed-through for a tire pressure control system of an agricultural tractor, includes a final drive housing designed as an axle trumpet and including a planetary transmission having a final drive shaft including a sun gear, a ring gear fixed in relation to the final drive housing, a planet carrier including an axial flange, and a plurality of planet gears rotatably mounted on a planet carrier and engaged with the sun gear and the ring gear, the planet carrier drivingly connected to an axle shaft rotatably mounted within the final drive housing and having an end portion rotationally fixed within an installation opening delimited by the axial flange, which includes a connecting channel for producing a compressed-air connection formed between a rotary feed-through extending on an outer circumference of the axial flange and intended for supplying compressed air and an air inlet opening on the end portion of the axle shaft and leading into a supply channel, which extends within the axle shaft and is intended to connect to a tire pressure control valve communicating with a tire interior of an associated rear wheel.

According to an aspect of the present disclosure, the connecting channel is designed as a bore extending radially within the axial flange.

According to an aspect of the present disclosure, the connecting channel is designed as a bore extending axially within the axial flange.

According to an aspect of the present disclosure, external toothing on the end portion of the axle shaft forms a rotationally fixed spline by engaging in internal toothing in the installation opening of the axial flange.

According to an aspect of the present disclosure, the connecting channel leads into an annular channel communicating with the air inlet opening, wherein the annular channel is formed in the axial flange along an outer circumference of the end portion of the axle shaft and an inner circumference of the installation opening.

According to an aspect of the present disclosure, the axle shaft is rotatably supported within the final drive housing in the region of axle portions facing away from one another by means of associated bearing points.

According to an aspect of the present disclosure, a rolling bearing supporting the axle shaft with respect to the final drive housing bears directly against the axial flange on an end side or is in contact therewith via an intermediate tolerance compensation ring.

According to an aspect of the present disclosure, a pressure-exerting plate for bracing the planet carrier or the axial flange with respect to the rolling bearing is provided on the end portion of the axle shaft, wherein a channel extension formed in the pressure-exerting plate produces a compressed-air connection between the connecting channel and the air inlet opening formed in the center of the end side of the end portion of the axle shaft.

According to an aspect of the present disclosure, a further rolling bearing supports the axle shaft in the region of an outer axle trumpet end with respect to the final drive housing.

According to an aspect of the present disclosure, the rotary feed-through communicates with an air supply channel, which is formed in the final drive housing and is intended to connect to a tire pressure control system.

According to an aspect of the present disclosure, an agricultural tractor includes the axle assembly of any of the embodiments disclosed herein.

The above and other features will become apparent from the following detailed description and accompanying drawings.

### BRIEF DESCRIPTION OF THE DRAWINGS

The axle assembly according to the disclosure with a rotary feed-through for a tire pressure control system is explained in more detail below with reference to the appended drawings. Components with an equivalent or comparable function are identified here by the same reference signs. In the figures:

FIG. 1 shows an overall view of a first example embodiment of the axle assembly according to the disclosure with a rotary feed-through for a tire pressure control system in an agricultural tractor;

FIG. 2 shows a detail view of the axle assembly shown in FIG. 1 in the region of the rotary feed-through; and

FIG. 3 shows a detail view of a second example embodiment of the axle assembly according to the disclosure, which is modified in relation to the first example embodiment in terms of the configuration of the rotary feed-through.

### DETAILED DESCRIPTION

The embodiments or implementations disclosed in the above drawings and the following detailed description are not intended to be exhaustive or to limit the present disclosure to these embodiments or implementations.

In addition to comparatively simple retrofitting solutions for tire pressure control with external compressed-air lines, which lead from a compressed-air compressor to a rotary feed-through attached to a wheel hub and from there to a tire pressure control valve, structurally integrated arrangements in the region of a rear axle, which are part of an axle assembly of a final drive unit of the agricultural tractor, are in particular also common. In the latter case, however, not only does the installation space requirement of the rotary feed-through restrict the ability to freely place associated bearing points along the rear axle, but also a structural integration of the compressed-air lines has an effect on the structural load-bearing capacity of the axle components through which said lines pass.

Against this background, the object of the present disclosure is to specify an axle assembly of the type mentioned at the outset that is improved in terms of the structural integration of the rotary feed-through.

This object is achieved by an axle assembly with a rotary feed-through for a tire pressure control system having the features of one or more embodiments disclosed herein.

The axle assembly according to the disclosure having a rotary feed-through for a tire pressure control system, in particular for an agricultural tractor, comprises a final drive housing, which is designed as an axle trumpet and has a planetary transmission, which has a final drive shaft, which can be driven by a rear-axle differential and has a sun gear, a ring gear, which is fixed in relation to the final drive housing, and a plurality of planet gears, which are rotatably mounted on a planet carrier and engage with both the sun gear and the ring gear, wherein the planet carrier is drivingly connected, in the region of an axial flange formed thereon, to an axle shaft rotatably mounted within the final drive housing, for which purpose an end portion of the axle shaft is received in a rotationally fixed manner within an installation opening delimited by the axial flange.

The final drive unit formed in this way is used to increase the torque of the axle shaft or of the agricultural tractor rear axle formed thereby with respect to the final drive shaft, depending on a respectively selected reduction ratio of the planetary transmission. In this case, the final drive shaft is drivingly connected via external toothing to complementary internal toothing of a transmission output shaft of a rear-axle differential of the agricultural tractor.

According to the disclosure, provision is now made for, within the axial flange, a connecting channel for producing a compressed-air connection to be formed between a rotary feed-through, which extends on an outer circumference of the axial flange and is intended for supplying compressed air, and an air inlet opening, which is provided on the end portion of the axle shaft. The air inlet opening leads in particular into a supply channel, which extends within the axle shaft and is intended to connect to a tire pressure control valve communicating with a tire interior of an associated rear wheel.

Since the rotary feed-through is assigned to the axial flange and therefore does not occupy any additional installation space along the axle shaft, the presence of said rotary feed-through does not restrict the ability to freely place the bearing points along the rear axle. The air inlet opening is also formed at the end portion and thus in a region of the axle shaft that is subjected to comparatively low torsional and bending stress. The air inlet opening and the adjoining supply channel therefore largely avoid having any effect on the structural load-bearing capacity of the axle shaft.

Final drive units based on the use of a planetary transmission are common in most agricultural tractors, which considerably simplifies structural integration of the axle assembly according to the disclosure for the case of an agricultural tractor to be equipped with a tire pressure control system.

Advantageous refinements of the axle assembly according to the disclosure can be found in the one or more embodiments disclosed herein.

The connecting channel can be designed as a bore extending radially and/or axially within the axial flange. The bore is formed in particular within the process of reworking the planet carrier produced as a casting. Depending on the position of the air inlet opening with respect to the rotary feed-through, it may be either a radially extending passage bore or a blind bore that initially extends axially in the direction of the end portion. The latter takes into account the fact that the air inlet opening should be displaced as far as possible into the region of the axle shaft end that is subjected to the least torsional and bending stress.

Furthermore, there is the possibility that external toothing on the end portion of the axle shaft forms a rotationally fixed spline by engaging in internal toothing in the installation opening of the axial flange. Specifically in the case of maintenance, this allows problem-free deinstallation of the axle shaft by simply pulling the externally toothed end portion out of the internally toothed installation opening.

In this case, provision may be made for the connecting channel to lead into an annular channel communicating with the air inlet opening, wherein the annular channel is formed in the axial flange along an outer circumference of the end portion of the axle shaft and/or an inner circumference of the installation opening. The encircling annular channel ensures that, irrespective of the angular position at which the rotationally fixed spline is produced during installation of the axle shaft, there is always a continuous compressed-air connection between the connecting channel and air inlet opening. This significantly simplifies installation of the axle shaft during assembly of the final drive unit.

In order to minimize stress on the axle shaft on account of bending loads acting via the rear wheel under operational conditions, it is advantageous if said axle shaft is rotatably supported within the final drive housing in the region of axle portions facing away from one another by means of associated bearing points.

Thus, on the one hand, provision may be made for a first or inner bearing point, in which a rolling bearing supporting the axle shaft with respect to the final drive housing bears directly against the axial flange on the end side or is in contact therewith via an intermediate tolerance compensation ring. The rolling bearing is, for example, a tapered roller bearing.

In this case, it is conceivable for a pressure-exerting plate for bracing the planet carrier or the axial flange formed thereon with respect to the rolling bearing to be provided on the end portion of the axle shaft, wherein a channel extension formed in the pressure-exerting plate produces a compressed-air connection between the connecting channel and the air inlet opening formed in this case in the center of the end side of the end portion of the axle shaft. The adjoining supply channel can pass through the center of the axle shaft along its axis of rotation, as a result of which possible effects on the structural load-bearing capacity of the axle shaft can be further reduced.

On the other hand, provision may be made for a second or outer bearing point, in which a further rolling bearing supports the axle shaft in the region of an outer axle trumpet end with respect to the final drive housing. The further rolling bearing may also be designed as a tapered roller bearing.

The rotary feed-through communicates with an air supply channel, which is formed in the final drive housing and is intended to connect to a tire pressure control system. With regard to the rotary feed-through, various common arrangements based on the use of radial lip seals or the like are possible.

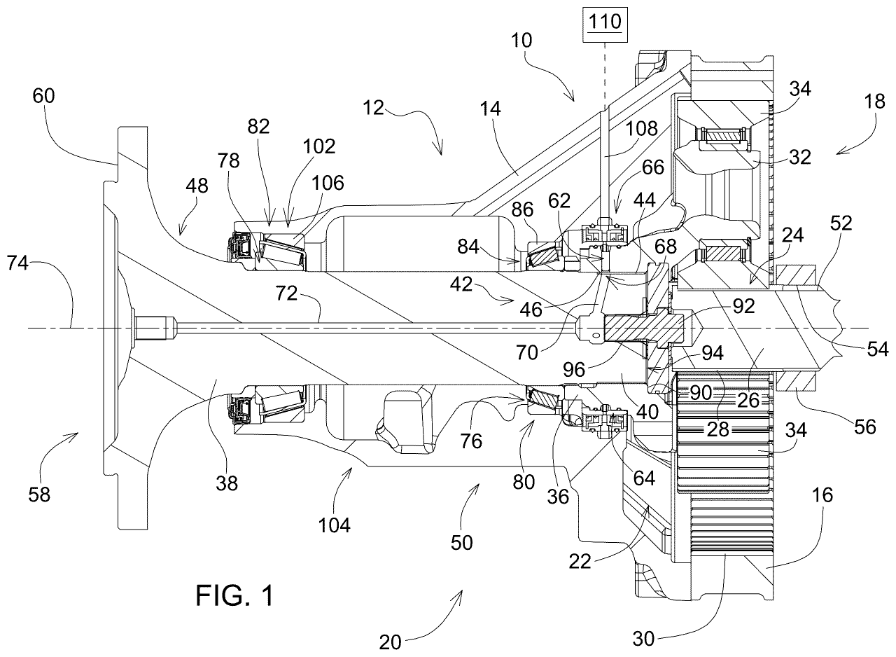

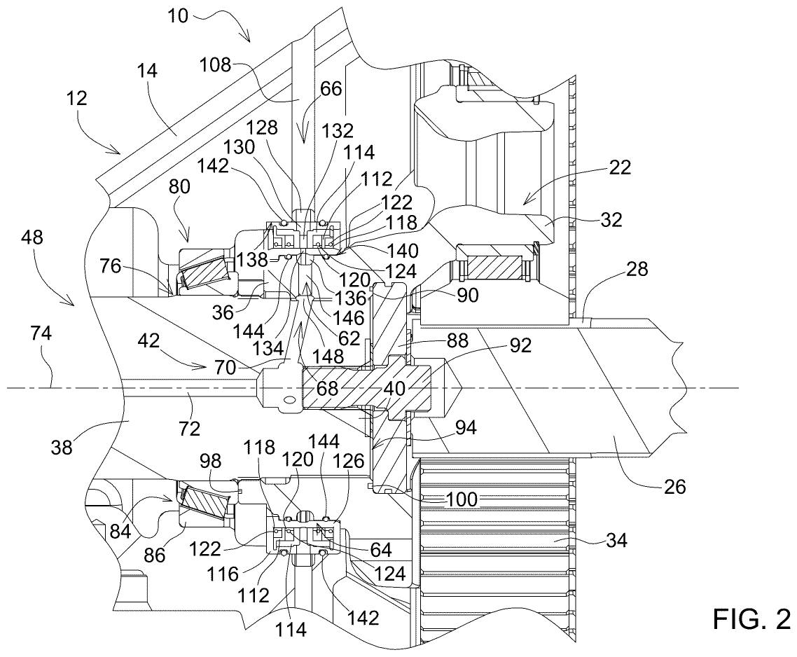

FIG. 1 shows a sectional illustration of an overall view of a first example embodiment of the axle assembly according to the disclosure with a rotary feed-through for a tire pressure control system in an agricultural tractor (not shown in more detail). In this case, FIG. 2 shows a detail view of the axle assembly according to the disclosure.

Accordingly, the axle assembly 10 comprises a final drive housing 14, which is designed as an axle trumpet 12 and is attached to an adjacent transmission housing 16 of a rear-axle differential 18 of the agricultural tractor 20. Located within the final drive housing 14 is a planetary transmission 22, which is comprised by the axle assembly 10 and has a sun gear shaft 24 in the form of a final drive shaft 26, which can be driven by the rear-axle differential 18 and has a sun gear 28, a ring gear 30, which is fixed in relation to the final drive housing 14, and a plurality of planet gears 34, which are rotatably mounted on a planet carrier 32 and engage with both the sun gear 28 and the ring gear 30. The planet carrier 32 is drivingly connected, in the region of an axial flange 36 formed thereon, to an axle shaft 38 rotatably mounted within the final drive housing 14. For this purpose, an end portion 40 of the axle shaft 38 is received in a rotationally fixed manner within an installation opening 42 delimited by the axial flange 36 by virtue of external toothing 44 on the end portion 40 of the axle shaft 38 forming a rotationally fixed spline by engaging in internal toothing 46 in the installation opening 42 of the axial flange 36. At the same time, the axle shaft 38 constitutes one of the two rear axles 48 of the agricultural tractor 20.

The final drive unit 48 formed in this way is used to increase the torque of the axle shaft 38 with respect to the final drive shaft 26, depending on a respectively selected reduction ratio of the planetary transmission 22. In this case, the final drive shaft 26 is drivingly connected via external toothing 52 to complementary internal toothing 54 of a transmission output shaft 56 of the rear-axle differential 18 of the agricultural tractor 20. In this case, the axle shaft 38 or the rear axle 46 formed thereby leads, at its free outer end 58, into a wheel hub 60, which is provided for attaching a rear wheel (not shown) of the agricultural tractor 20.

Within the axial flange 36, a connecting channel 62 for producing a compressed-air connection is formed between a rotary feed-through 66, which extends on an outer circumference 64 of the axial flange 36 and is intended for supplying compressed air, and an air inlet opening 68, which is provided on the end portion 40 of the axle shaft 38. The air inlet opening 68 or a passage bore 70 forming the latter leads into a supply channel 72, which extends within the axle shaft 38 and is intended to connect to a tire pressure control valve communicating with a tire interior of the rear wheel or an associated rear tire. The latter is arranged on a wheel rim of the rear wheel and is accordingly not illustrated in FIG. 1 or 2. The supply channel 72 passes through the center of the axle shaft 38 along its axis of rotation 74.

According to the example, FIGS. 1 and 2 illustrate the axle trumpet 12 attached to the left-hand side of the transmission housing 16. In this case, the axle trumpet located on the right-hand side has a mirror-symmetrical construction.

In order to minimize stress on the axle shaft 38 on account of bending loads acting via the rear wheel under operational conditions, said axle shaft is rotatably supported within the final drive housing 14 in the region of axle portions 76, 78 facing away from one another by means of associated bearing points 80, 82.

Thus, on the one hand, provision is made for a first or inner bearing point 80, in which a rolling bearing 84 supporting the axle shaft 38 with respect to the final drive housing 14 bears directly against the axial flange 36 on the end side. Alternatively, the rolling bearing 84 is in contact with the axial flange 36 via an intermediate tolerance compensation ring. The rolling bearing is, for example, a tapered roller bearing. The rolling bearing 84 is a tapered roller bearing 86. In order to brace the planet carrier 32 or the axial flange 36 formed thereon with respect to the tapered roller bearing 86, use is made of a pressure-exerting plate 88, which bears along a shoulder 90, which encircles the inside of the axial flange 36, and the contact pressure of which can be set in accordance with the respective requirements by means of a bolt 92. For this purpose, the bolt 92 extends through the pressure-exerting plate 88 into a central thread 96 formed on an end side 94 of the axle shaft 38. At the same time, the bolt 92 forms an inner termination of the supply channel 72 extending within the axle shaft 38. Annular seals 98, 100 provided in the contact region between the axial flange 36 and rolling bearing 84 or pressure-exerting plate 88 serve for pressure sealing toward the outside (see FIG. 2).

On the other hand, provision is made for a second or outer bearing point 82, in which a further rolling bearing 102 supports the axle shaft 38 in the region of an outer axle trumpet end 104 with respect to the final drive housing 14. The further rolling bearing 102 is also designed as a tapered roller bearing 106.

As can be seen in particular in the detail view of the axle assembly 10 in FIG. 2, the rotary feed-through 66 communicates with an air supply channel 108, which is formed in the final drive housing 14 and is intended to connect to a tire pressure control system 110, including a compressor-fed compressed-air supply and an associated controller (e.g., a controller including a processor and memory), which can be operated by the driver via a user interface (not shown) located in the agricultural tractor 20. By way of example, the rotary feed-through 66 comprises radial lip seals 112, 114, which are arranged in pairs and are securely attached to an outer annular sleeve 116 and terminate at their free ends in respective sealing lips 118, 120, which are pressed against an inner annular sleeve 126 by means of associated worm springs 122, 124, wherein said annular sleeve extends on the outer circumference 64 of the axial flange 36.

In this case, the outer annular sleeve 116 received within the surrounding final drive housing 14 has, along its circumference, a passage opening 130, which communicates with the air supply channel 108 via an outer annular channel 128 and passes into a passage region 132, which extends between the two radial lip seals 112, 114 and is in turn adjoined by a multiplicity of radial bores 134 formed along the circumference of the inner annular sleeve 126. Said radial bores in turn lead into an inner annular channel 136, which is formed along the outer circumference 64 of the axial flange 36 and into which the connecting channel 62 finally leads. The two annular sleeves 116, 126 are received in the region of an outer or inner fit seat 138, 140 in the final drive housing 14 or on the outer circumference 64 of the axial flange 36. Further annular seals 142, 144 extending therein are used for pressure sealing toward the outside.

According to the example, the connecting channel 62 is formed as a passage bore 146 extending radially within the axial flange 36. The passage bore 146 is formed within the process of reworking the planet carrier 32 produced as a casting.

As can be further seen in FIG. 2, the connecting channel 62 leads into a further annular channel 148 communicating with the air inlet opening 68, wherein the further annular channel 148 is formed in the axial flange 36 along an outer circumference of the end portion 40 of the axle shaft 38 and/or an inner circumference of the installation opening 42. The encircling further annular channel 148 ensures that, irrespective of the angular position at which the rotationally fixed spline is produced during installation of the axle shaft 38, there is always a continuous compressed-air connection between the connecting channel 62 and air inlet opening 68. This significantly simplifies installation of the axle shaft 38 during assembly of the final drive unit 48.

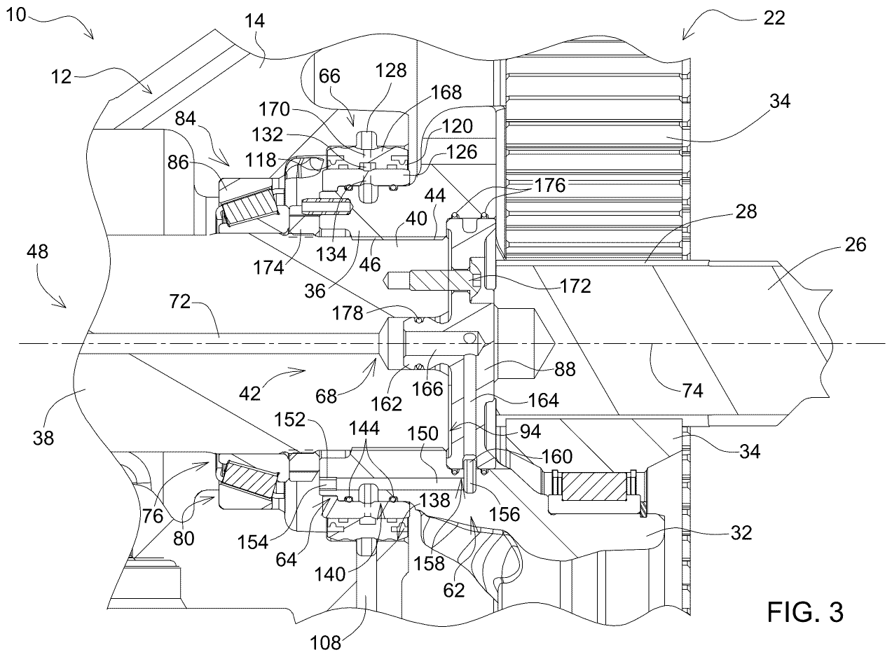

FIG. 3 shows a detail view of a second example embodiment of the axle assembly according to the disclosure, which is modified in relation to the first example embodiment in terms of the configuration of the rotary feed-through 66.

This differs, inter alia, in terms of the path of the connecting channel 62 within the axial flange 36, which, in accordance with the changed position of the air inlet opening 68 in relation to the rotary feed-through 66 in the direction of the axle shaft end, is a blind bore 150 that initially extends axially in the direction of the end portion 40 of the axle shaft 38, the outer opening 152 of which is sealed by means of a closure element 154. The axially extending blind bore 150 merges into a radially extending milled-out portion 156, which enters an annular channel 160, which is provided along an outer circumference 158 of the pressure-exerting plate 88 and in turn communicates, via radial or axial bores 164, 166 formed within the pressure-exerting plate 88 or a fastening pin 162 projecting therefrom, with the supply channel 72 extending within the axle shaft 38. Accordingly, the radial or axial bores 164, 166 constitute a channel extension formed in the pressure-exerting plate 88 for producing a compressed-air connection between the connecting channel 62 and the air inlet opening 68, which is formed in the center of the end side 94 of the end portion 40 of the axle shaft 38.

There are also deviations in terms of the configuration of the rotary feed-through 66 used. In the present case, this comprises a single radial lip seal 168, on which the two sealing lips 118, 120 are formed in one piece. In this case, the radial lip seal 168 is received within the surrounding final drive housing 14 so as to directly bear against the latter. The outer annular channel 128 is connected to the passage region 132 via openings 170 provided along the circumference of the radial lip seal 168.

A plurality of bolts 172 are used for fastening the pressure-exerting plate 88, which in the present case bears directly against the end side 94 of the axle shaft 38. For illustrative purposes, only a single bolt 172 can be seen in FIG. 3. The rolling bearing 84 assigned to the first or inner bearing point 80 is preloaded in this case by means of a shaft nut 174. Annular seals 176, 178 extending along the outer circumference 158 of the pressure-exerting plate 88 or on the fastening pin 162 are in this case used for pressure sealing toward the outside.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. An axle assembly having a rotary feed-through for a tire pressure control system of an agricultural tractor, comprising:
a final drive housing designed as an axle trumpet and including a planetary transmission having a final drive shaft including a sun gear, a ring gear fixed in relation to the final drive housing, a planet carrier including an axial flange, and a plurality of planet gears rotatably mounted on a planet carrier and engaged with the sun gear and the ring gear, the planet carrier drivingly connected to an axle shaft rotatably mounted within the final drive housing and having an end portion rotationally fixed within an installation opening delimited by the axial flange, which includes a connecting channel for producing a compressed-air connection formed between a rotary feed-through extending on an outer circumference of the axial flange and intended for supplying compressed air and an air inlet opening on the end portion of the axle shaft and leading into a supply channel, which extends within the axle shaft and is intended to connect to a tire pressure control valve communicating with a tire interior of an associated rear wheel.

2. The axle assembly of claim 1, wherein the connecting channel is designed as a bore extending radially within the axial flange.

3. The axle assembly of claim 1, wherein the connecting channel is designed as a bore extending axially within the axial flange.

4. The axle assembly of claim 1, wherein external toothing on the end portion of the axle shaft forms a rotationally fixed spline by engaging in internal toothing in the installation opening of the axial flange.

5. The axle assembly of claim 1, wherein the connecting channel leads into an annular channel communicating with the air inlet opening, wherein the annular channel is formed in the axial flange along an outer circumference of the end portion of the axle shaft and an inner circumference of the installation opening.

6. The axle assembly of claim 1, wherein the axle shaft is rotatably supported within the final drive housing in the region of axle portions facing away from one another by means of associated bearing points.

7. The axle assembly of claim 6, wherein a rolling bearing supporting the axle shaft with respect to the final drive housing bears directly against the axial flange on an end side or is in contact therewith via an intermediate tolerance compensation ring.

8. The axle assembly of claim 7, wherein a pressure-exerting plate for bracing the planet carrier or the axial flange with respect to the rolling bearing is provided on the end portion of the axle shaft, wherein a channel extension formed in the pressure-exerting plate produces a compressed-air connection between the connecting channel and the air inlet opening formed in the center of the end side of the end portion of the axle shaft.

9. The axle assembly of claim 7, wherein a further rolling bearing supports the axle shaft in the region of an outer axle trumpet end with respect to the final drive housing.

10. The axle assembly of claim 1, wherein the rotary feed-through communicates with an air supply channel, which is formed in the final drive housing and is intended to connect to a tire pressure control system.

11. An agricultural tractor including axle assembly having a rotary feed-through for a tire pressure control system, comprising:
a final drive housing designed as an axle trumpet and including a planetary transmission having a final drive shaft, which include a sun gear and is driven by a rear-axle differential, a ring gear fixed in relation to the final drive housing, a planet carrier including an axial flange, and a plurality of planet gears rotatably mounted on a planet carrier and engaged with the sun gear and the ring gear, the planet carrier drivingly connected to an axle shaft rotatably mounted within the final drive housing and having an end portion rotationally fixed within an installation opening delimited by the axial flange, which includes a connecting channel for producing a compressed-air connection formed between a rotary feed-through extending on an outer circumference of the axial flange and intended for supplying compressed air and an air inlet opening on the end portion of the axle shaft and leading into a supply channel, which extends within the axle shaft and is intended to connect to a tire pressure control valve communicating with a tire interior of an associated rear wheel.

12. The agricultural tractor of claim 11, wherein the connecting channel is designed as a bore extending radially within the axial flange.

13. The agricultural tractor of claim 11, wherein the connecting channel is designed as a bore extending axially within the axial flange.

14. The agricultural tractor of claim 11, wherein external toothing on the end portion of the axle shaft forms a rotationally fixed spline by engaging in internal toothing in the installation opening of the axial flange.

15. The agricultural tractor of claim 11, wherein the connecting channel leads into an annular channel communicating with the air inlet opening, wherein the annular channel is formed in the axial flange along an outer circumference of the end portion of the axle shaft and an inner circumference of the installation opening.

16. The agricultural tractor of claim 11, wherein the axle shaft is rotatably supported within the final drive housing in the region of axle portions facing away from one another by means of associated bearing points.

17. The agricultural tractor of claim 16, wherein a rolling bearing supporting the axle shaft with respect to the final drive housing bears directly against the axial flange on an end side or is in contact therewith via an intermediate tolerance compensation ring.

18. The agricultural tractor of claim 17, wherein a pressure-exerting plate for bracing the planet carrier or the axial flange with respect to the rolling bearing is provided on the end portion of the axle shaft, wherein a channel extension formed in the pressure-exerting plate produces a compressed-air connection between the connecting channel and the air inlet opening formed in the center of the end side of the end portion of the axle shaft.

19. The agricultural tractor of claim 17, wherein a further rolling bearing supports the axle shaft in the region of an outer axle trumpet end with respect to the final drive housing.

20. The agricultural tractor of claim 11, wherein the rotary feed-through communicates with an air supply channel, which is formed in the final drive housing and is intended to connect to a tire pressure control system.
